(19) United States
(12) Patent Application Publication
(10) Pub. No.: US 2010/0224166 A1
(43) Pub. Date: Sep. 9, 2010

(54) HOMOGENEOUS CHARGE COMPRESSION IGNITION ENGINE

(76) Inventor: Hiroshi Kuzuyama, Kariya-shi (JP)

Correspondence Address: Locke Lord Bissell & Liddell LLP;Attn: IP Docketing, Three World Financial Center, New York, NY, 10281-2101, US

(21) Appl. No.: 12/310,600

(22) PCT Filed: Nov. 29, 2007
(86) PCT No.: PCT/JP2007/073530

§ 371 Date: Feb. 28, 2009

(30) Foreign Application Priority Data
Nov. 30, 2006 (JP) 2006 323847

(51) Int. Cl. F02B 17/00; F02B 31/00

(52) U.S. Cl. 123/295; 123/306

(57) ABSTRACT

An HCCI engine capable of switching combustion mode between SI combustion and HCCI combustion is disclosed. At least one swirl port and at least one tumble port communicate with a combustion chamber of the HCCI engine. In a first switching period in which the SI combustion is switched to the HCCI combustion, intake air is supplied to the combustion chamber solely through the swirl port. In a second switching period in which the HCCI combustion is switched to the SI combustion, the intake air is supplied to the combustion chamber through at least the tumble port.

### TECHNICAL FIELD

The present invention relates to a homogeneous charge compression ignition engine that switches its combustion mode between the spark ignition combustion and the homogeneous charge compression ignition combustion.

### BACKGROUND ART

Japanese Laid-Open Patent Publication No. 2003-193872 discloses an example of the homogeneous charge compression ignition engine (an HCCI engine) that switches its combustion mode between the spark ignition combustion (SI combustion) and the homogeneous charge compression ignition combustion (HCCI combustion). The HCCI engine has a variable compression ratio mechanism and operates at a high compression ratio in the HCCI combustion and a low compression ratio in the SI combustion. The HCCI engine lowers effective compression ratio by retarding the closing timings of the intake valves in the switching period from the HCCI combustion at the high compression ratio to the SI combustion at the low compression ratio. In this manner, the HCCI combustion mode is quickly ended and switched smoothly to the SI combustion mode.

The variable compression ratio mechanism described in Japanese Laid-Open Patent Publication No. 2003-193872 smoothly switches its combustion mode from the homogeneous charge compression ignition combustion to the spark ignition combustion. However, the mechanism is configured in a complicated manner, which greatly increases the costs for manufacturing the mechanism. Also, the weight of the mechanism is greatly disadvantageous.

The in-cylinder gas temperature in the steady operation of the SI combustion is higher than the in-cylinder gas temperature in the steady operation of the HCCI combustion. Thus, the temperature of the wall surface of each cylinder is relatively high in the SI combustion. This may cause premature ignition and/or knocking in the switching period from the SI combustion to the HCCI combustion. In contrast, the temperature of the wall surface of each cylinder is relatively low in the HCCI combustion. Thus, misfire may occur in the switching period from the HCCI combustion to the SI combustion. These problems caused by the high or low in-cylinder gas temperature in switching of the combustion mode are not addressed to by the technique of Japanese Laid-Open Patent Publication No. 2003-193872.

### SUMMARY OF THE INVENTION

Accordingly, it is an objective of the present invention to provide a homogeneous charge compression ignition engine that suppresses premature ignition and knocking in a switching period from the spark ignition combustion to the homogeneous charge compression ignition combustion, and a misfire in a switching period from the homogeneous charge compression ignition combustion to the spark ignition combustion.

To achieve the foregoing objectives and in accordance with one aspect of the present invention, a homogeneous charge compression ignition engine having a combustion chamber is provided. The engine is capable of switching combustion mode between a spark ignition combustion and a homogeneous charge compression ignition combustion. The engine includes a plurality of intake ports, an intake port opening/closing device, and a control section. The intake ports communicate with the combustion chamber. The intake ports include at least one first port that is a swirl port and at least one second port that is a non-dedicated swirl port. The intake port opening/closing device selectively opens and closes at least the second port. The control section controls the intake port opening/closing device. In a first switching period, or a switching period in which the spark ignition combustion is switched to the homogeneous charge compression ignition combustion, the control section controls the intake port opening/closing device to close the second port so that an intake air is supplied to the combustion chamber only through the first port. In a second switching period, or a switching period in which the homogeneous charge compression ignition combustion is switched to the spark ignition combustion, the control section controls the intake port opening/closing device to open the second port so that the intake air is supplied through at least the second port.

### BRIEF DESCRIPTION OF THE DRAWINGS

FIG. 1 is a schematic plan view mainly showing one of the cylinders of a homogeneous charge compression ignition engine according to an embodiment of the present invention;

FIG. 2 is a schematic plan view illustrating the engine shown in FIG. 1, in a state where only a swirl port is being used;

FIG. 3 is a schematic plan view illustrating the engine shown in FIG. 1, in a state where only a tumble port is being used;

FIG. 4 is a left side view schematically showing the engine shown in FIG. 2;

FIG. 5 is a right side view schematically showing the engine shown in FIG. 3;

FIG. 6 is a graph representing fluctuation of the temperature in a combustion chamber of the engine shown in FIG. 1 before, during, and after a first switching period;

FIG. 7 is a graph representing fluctuation of the temperature in the combustion chamber of the engine shown in FIG. 1 before, during, and after a second switching period; and

FIG. 8 is a graph representing fluctuation of the air-fuel ratio in the combustion chamber of the engine shown in FIG. 1 before, during, and after the second switching period.

### BEST MODE FOR CARRYING OUT THE INVENTION

A preferred embodiment of the present invention will now be described with reference to the attached drawings.

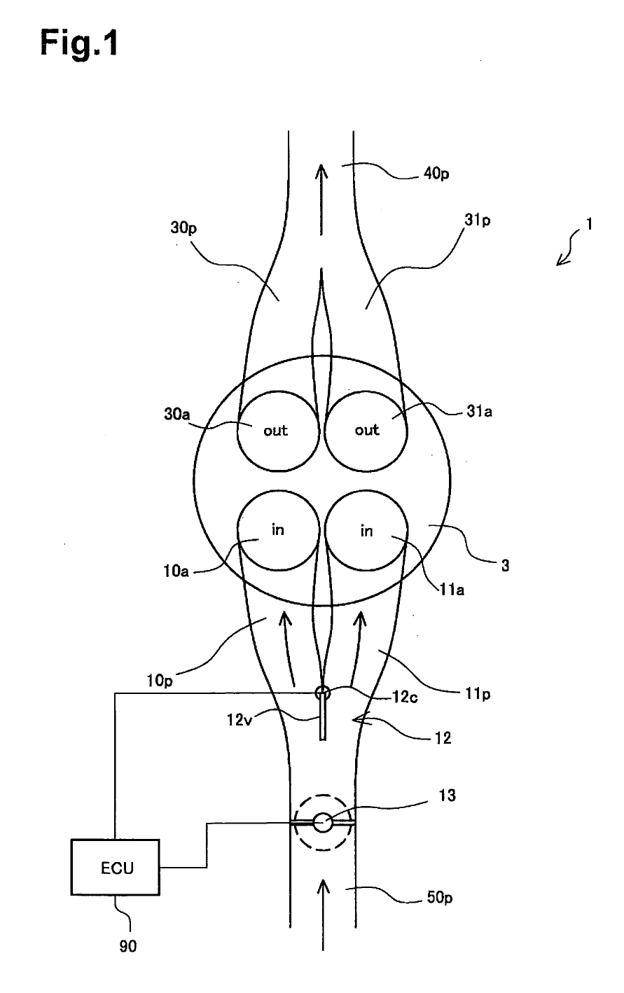

The configuration of a homogeneous charge compression ignition engine (an HCCI engine) 1 according to one embodiment of the present invention as a whole will be explained with reference to FIG. 1. The drawing only schematically shows the HCCI engine 1. For example, ignition plugs 2p and intake and exhaust valves 10v, 30v, which will be described later, are omitted.

The HCCI engine 1 switches the combustion mode between the spark ignition combustion (SI combustion) and the homogeneous charge compression ignition combustion (HCCI combustion) in correspondence with the operating conditions (engine load and engine speed), when necessary. This allows the HCCI engine 1 to operate with low fuel consumption in the HCCI combustion and with high output in the SI combustion.

As shown in FIG. 1, the HCCI engine 1 has a plurality of cylinders (only one is shown). Each of the cylinders has a combustion chamber 3, two intake ports 10p, 11p communicating with the combustion chamber 3, two exhaust ports 30p, 31p also communicating with the combustion chamber 3, and a throttle 13. Although, in the present embodiment, each cylinder has two intake ports, the number of the intake ports may be any other suitable value as long as the number is plural. That is, the cylinder may include three or more intake ports. Intake air passes through the intake ports 10p, 11p and reaches the combustion chamber 3 through corresponding openings 10a, 11a. Exhaust gas is discharged from the combustion chamber 3 and reaches the exhaust ports 30p, 31p through corresponding openings 30a, 31a. The two intake ports 10p, 11p are provided as branches divided from a common upstream intake port 50p. The two exhaust ports 30p, 31p are merged into a common downstream exhaust port 40p. The throttle 13, which serves as an intake air amount adjustment device, is arranged in the upstream intake port 50p and adjusts the amount of the intake air supplied to the combustion chamber 3. Although the intake air amount adjustment device is embodied by the throttle 13 in the present embodiment, the device may be modified to any other suitable component. The HCCI engine 1 has an electronic control unit (ECU) 90 serving as a control section. The ECU 90 controls the operation of the throttle 13 and the intake and exhaust valves 10v, 30v.

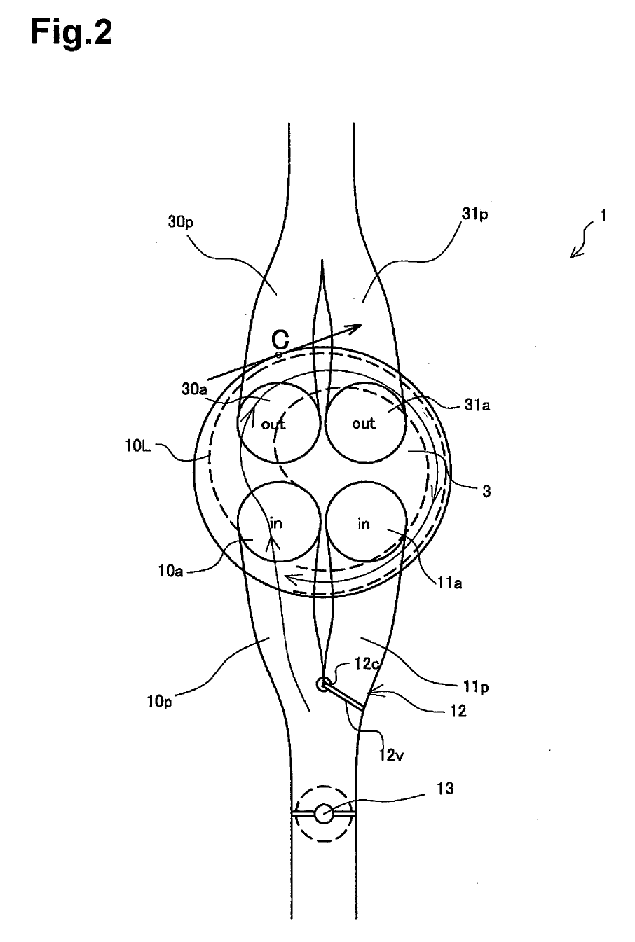

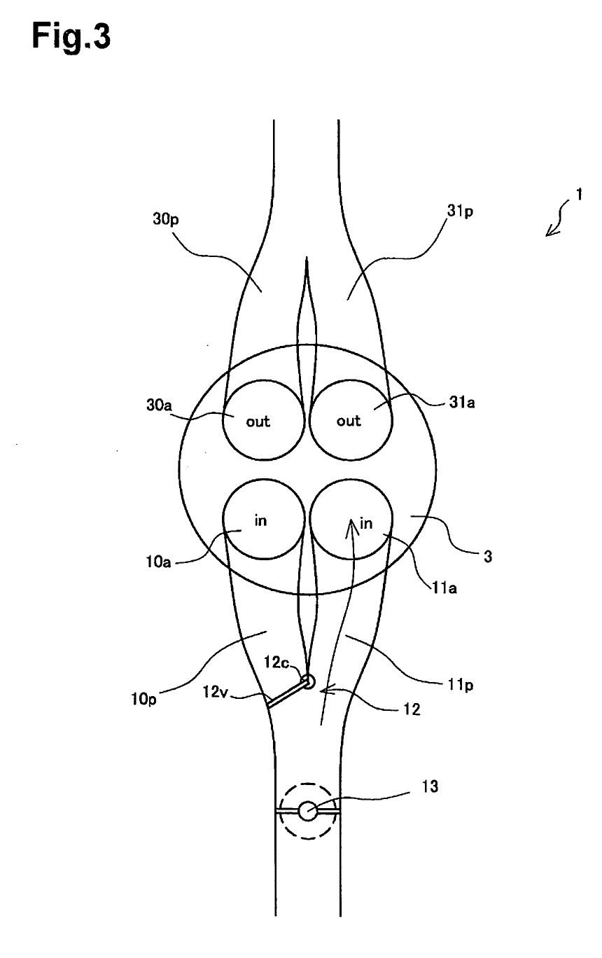

Subsequently, with reference to FIGS. 2 and 3, the configurations of the intake ports 10p, 11p will be explained in detail. In the present embodiment, the intake port 10p is a swirl port (a first port) and the intake port 11p is a tumble port (a second port). Each of the cylinders of the embodiment includes one swirl port 10p and one tumble port 11p. The number of swirl ports 10p or tumble ports 11p provided in each cylinder may be more than two as long as each cylinder has at least one swirl port 10p and at least one tumble port 11p. That is, for example, each cylinder may have two swirl ports and one tumble port or one swirl port and two tumble ports. An intake port opening/closing valve (an intake port opening/closing device) 12 is arranged at the branching point between the swirl port 10p and the tumble port 11p. The path of the intake air passing through the two intake ports 10p, 11p is switched by controlling the intake port opening/closing valve 12. Specifically, the path is switched between a path including only one of the intake ports 10p, 11p and a path including both of the intake ports 10p, 11p.

Switching of the intake ports will be described in the following.

The intake port opening/closing valve 12 has a rotary shaft 12c and a valve 12v, which rotates in cooperation with rotation of the shaft 12c. The intake port opening/closing valve 12 is controlled by the ECU 90 to selectively open and close the swirl port 10p and the tumble port 11p, as illustrated in FIGS. 1 to 3. In the state illustrated in FIG. 1, the valve 12v is located at an intermediate position. In this state, the intake air passes through both of the swirl port 10p and the tumble port 11p and reaches the combustion chamber 3. In the state illustrated in FIG. 2, the valve 12v is arranged in such a manner as to close the tumble port 11p (to form a lid that closes the tumble port 11p). In this state, the intake air flows only through the swirl port 10p before reaching the combustion chamber 3. In the state illustrated in FIG. 3, the valve 12v is arranged in such a manner as to block the swirl port 10p (to form a lid that closes the swirl port 10p). In this state, the intake air flows exclusively through the tumble port 11p before being introduced into the combustion chamber 3. Any one of these states illustrated in FIGS. 1 to 3 is selected as needed through control by the ECU 90 in correspondence with the operating state of the HCCI engine 1.

Alternatively, the intake port opening/closing valve 12 may be replaced by an intake port opening/closing device that selectively opens and closes at least the tumble port 11p. The intake port opening/closing device may be formed by, for example, two lid portions that correspond to the intake ports 10p, 11p. In this case, the lid portions are controlled by the ECU 90 in such a manner that the corresponding one of the intake ports 10p, 11p is selectively opened and closed.

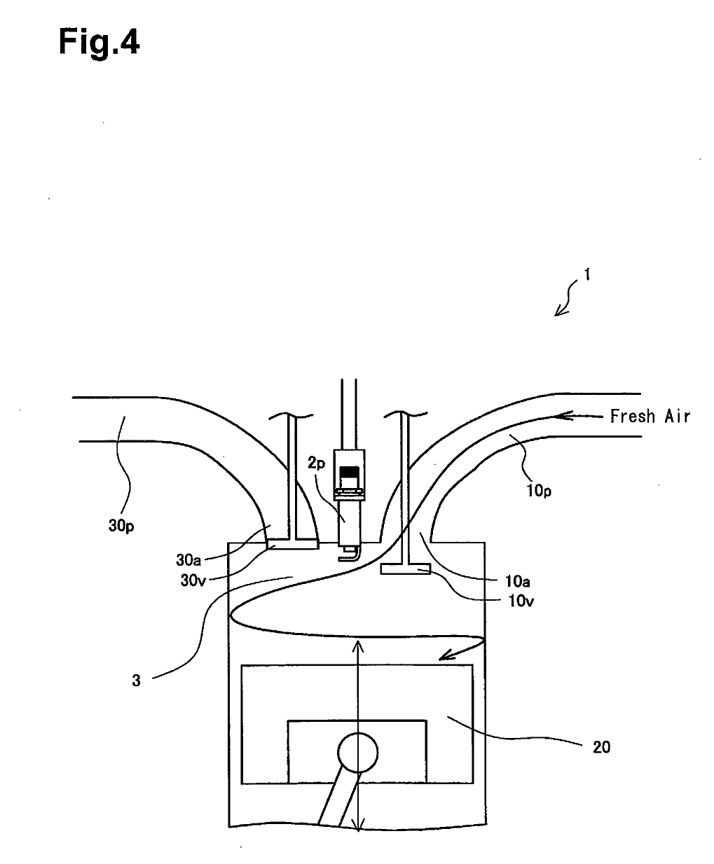

The swirl port 10p will hereafter be explained more specifically with reference to FIGS. 2 and 4. As shown in FIG. 4, the HCCI engine 1 has an intake valve 10v selectively opening and closing the swirl port 10p, an exhaust valve 30v selectively opening and closing the exhaust port 30p, and an ignition plug 2p used in the SI combustion. FIG. 4 illustrates the state in which the intake valve 10v is open and the exhaust valve 30v is closed.

The swirl port 10p is shaped in such a manner as to generate a swirl flow in the combustion chamber 3. Specifically, the swirl port 10p supplies intake air (fresh air) in a tangential direction of the wall surface of the combustion chamber 3 (by way of example, the tangential direction at point C on the wall surface of the combustion chamber 3 is illustrated in FIG. 2). This allows the swirl port 10p to positively produce an intense swirl flow compared to the tumble port 11p, which will be described later. The swirl flow is a vortex moving substantially parallel with a plane perpendicular to the axial direction of the cylinder and flows along the wall surface (the bore wall) of the combustion chamber 3, as illustrated in FIGS. 2 and 4. In FIG. 2, the swirl flow moves in the combustion chamber 3 along the path 10L represented by the broken lines. This increases cooling efficiency (heat exchange efficiency) in the combustion chamber 3 compared to a case involving no movement of the intake air. The path 10L is simply an example and the flowing path of the swirl flow is not restricted to the illustrated path 10L.

Even a tumble flow generates, the intake air is cooled by the bore wall surface, the top surface of the piston, and the lower surface of the cylinder head. However, since a relatively great amount of coolant flows in a coolant passage that cools the bore wall surface and the swirl flow contacts the bore wall surface by a great contact area, the swirl flow efficiently cools the intake air compared to the tumble flow.

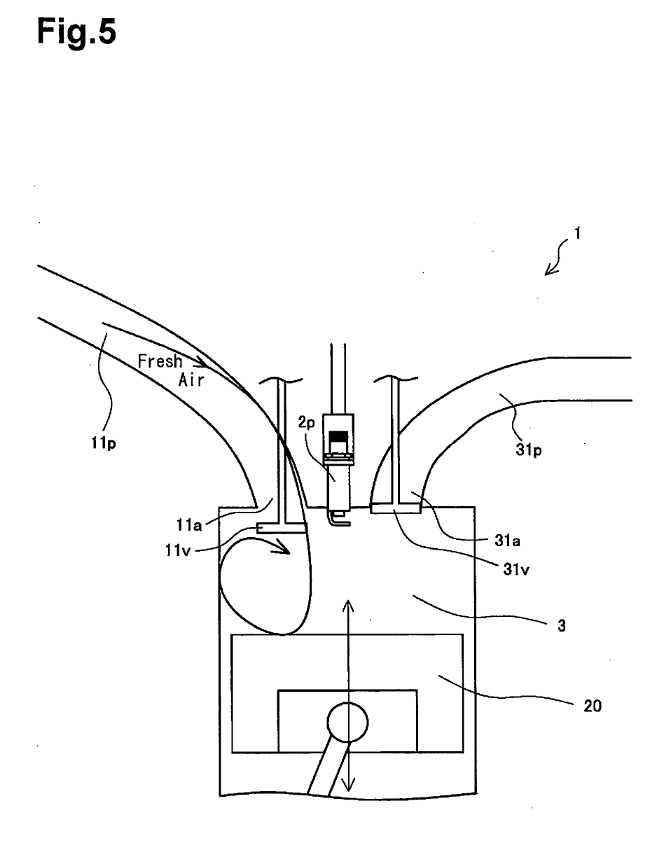

Next, the tumble port 11p will be explained more specifically with reference to FIGS. 3 and 5. As shown in FIG. 5, the HCCI engine 1 has an intake valve 11v selectively opening and closing the tumble port 11p and an exhaust valve 31v selectively opening and closing the exhaust port 31p. FIG. 5 illustrates the state in which the intake valve 11v is open and the exhaust valve 31v is closed.

The tumble port 11p supplies intake air (fresh air) to the combustion chamber 3 in a direction crossing the wall surface of the combustion chamber 3 and in a direction of stroke of a piston 20. This produces a tumble flow in the combustion chamber 3. The tumble flow is a vortex (a vertical vortex) proceeding substantially parallel with the stroke direction of the piston 20. With reference to FIGS. 3 and 5, the tumble flow does not flow along the wall surface (the bore wall) of the combustion chamber 3. To form the tumble flow, the intake air is sent linearly from the tumble port 11p toward the proximity of the radial center of the combustion chamber 3. This prevents the intake air from moving in a manner diffused in the combustion chamber 3, thus containing the intake air in a certain range.

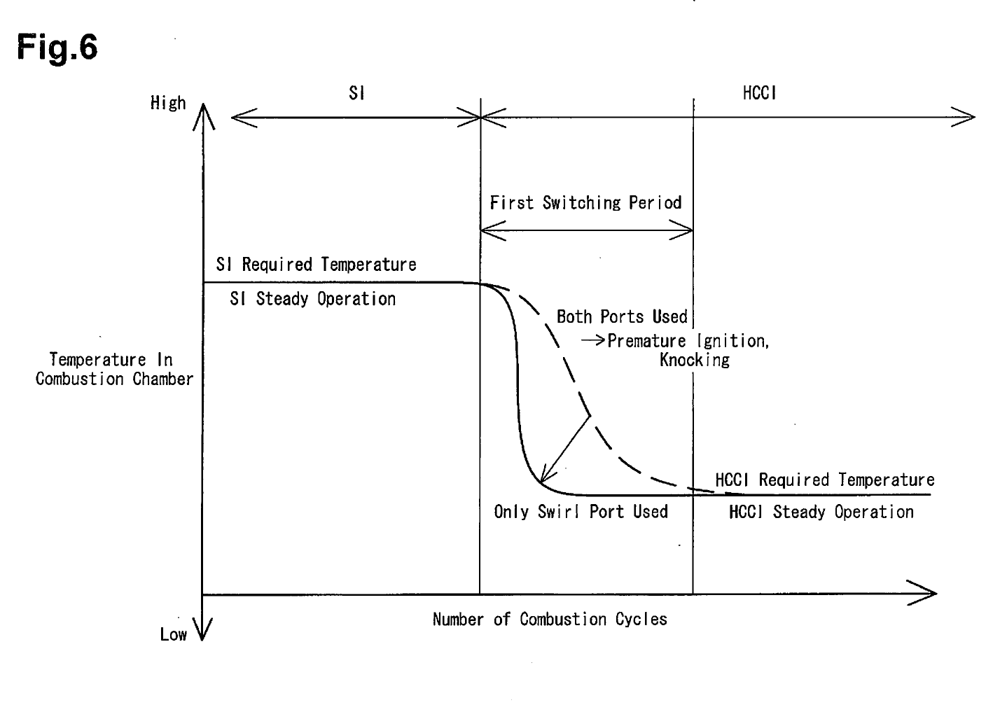

The operation of the HCCI engine 1, which is configured as described above, will hereafter be explained with reference to FIGS. 6 to 8. The axis of abscissas of each of the graphs of FIGS. 6 to 8 represents the number of combustion cycles.

In the steady operation of the SI combustion and that of the HCCI combustion, the ECU 90 controls the intake port opening/closing valve 12 in such a manner that the swirl port 10p and the tumble port 11p are both used as the intake ports (see FIG. 1).

In the present embodiment, the switching period from the SI combustion to the HCCI combustion is referred to as the first switching period (see FIG. 6). In the first switching period, the ECU 90 controls the intake port opening/closing valve 12 in such a manner as to close the tumble port 11p and supply the intake air to the combustion chamber 3 only through the swirl port 10p (see FIGS. 2 and 4).

As is clear from FIG. 6, the temperature in the combustion chamber 3 in the steady operation of the SI combustion (the SI required temperature) is higher than the temperature of the steady operation of the HCCI combustion (the HCCI required temperature). In FIG. 6, the curve of a broken line shows the temperature in the combustion chamber 3 when the swirl port 10p and the tumble port 11p are both used as the intake ports in the first switching period (the state illustrated in FIG. 1). As indicated by the curve of the broken line, the temperature in the combustion chamber 3 does not quickly drop in the first switching period. This may lead to premature ignition and/or knocking, thus hampering smooth switching from the SI combustion to the HCCI combustion. To avoid this, in the present embodiment, the HCCI engine 1 uses only the swirl port 10p as the intake port in the first switching period (see FIGS. 2 and 4) to efficiently cool the interior of the combustion chamber 3. Thus, as indicated by the curve of the solid line in FIG. 6, the temperature in the combustion chamber 3 rapidly lowers to the HCCI required temperature. This suppresses premature ignition and knocking and allows smooth switching of the combustion mode from the SI combustion to the HCCI combustion.

More specifically, if the intake air that has passed through the upstream intake port 50p flows through the swirl port 10p and the tumble port 11p, the intake air sent to the tumble port 11p decreases the cooling efficiency in the combustion chamber 3, compared to a case in which solely the swirl port 10p is used. Thus, the combustion chamber 3 is efficiently cooled by using the swirl port 10p exclusively.

In the first switching period, the ECU 90 controls the intake port opening/closing valve 12 in such a manner that the tumble port 11p is held in a closed state until the temperature in the combustion chamber 3 reaches the HCCI required temperature. In other words, the intake port opening/closing valve 12 is controlled in such a manner that the closed state of the tumble port 11p is maintained until switching of the combustion mode is completed. Thus, switching of the combustion mode from the SI combustion to the HCCI combustion is reliably and smoothly carried out.

In the present embodiment, as has been described, the two intake ports communicate with the combustion chamber 3. However, for example, two swirl ports and one tumble port may communicate with the combustion chamber 3. In this case, all of the three ports are used in the steady operation of the SI combustion while one or two swirl ports are used in the first switching period. In other words, the number of the swirl ports that are used in the first switching period may be any suitable count as long as the tumble port is maintained closed during this period.

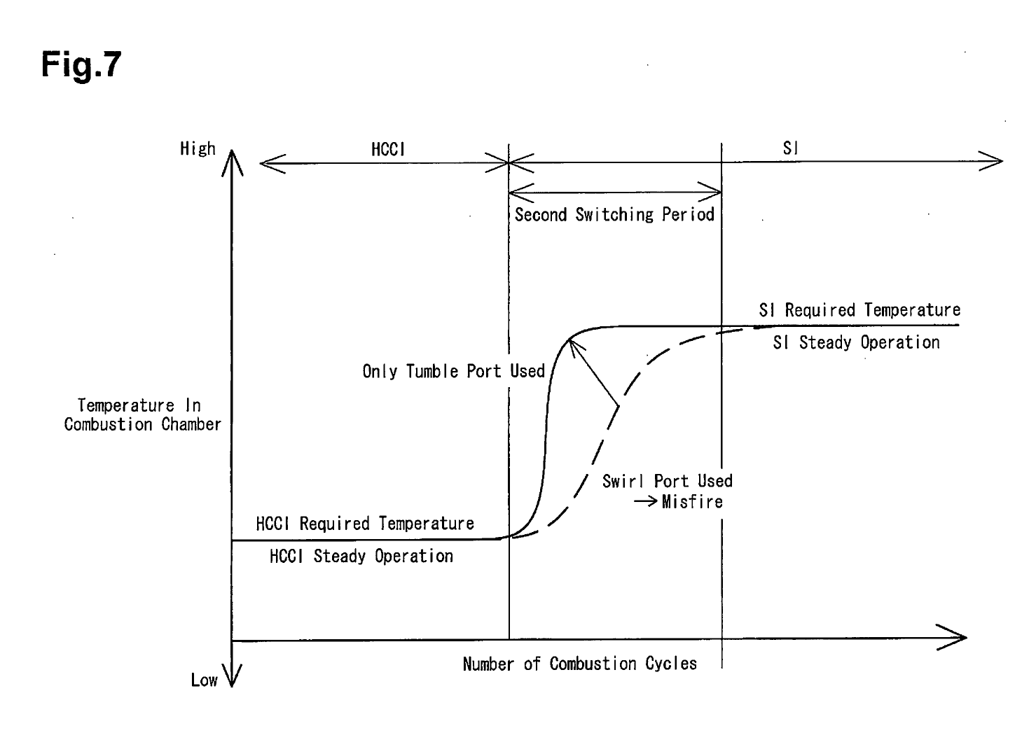

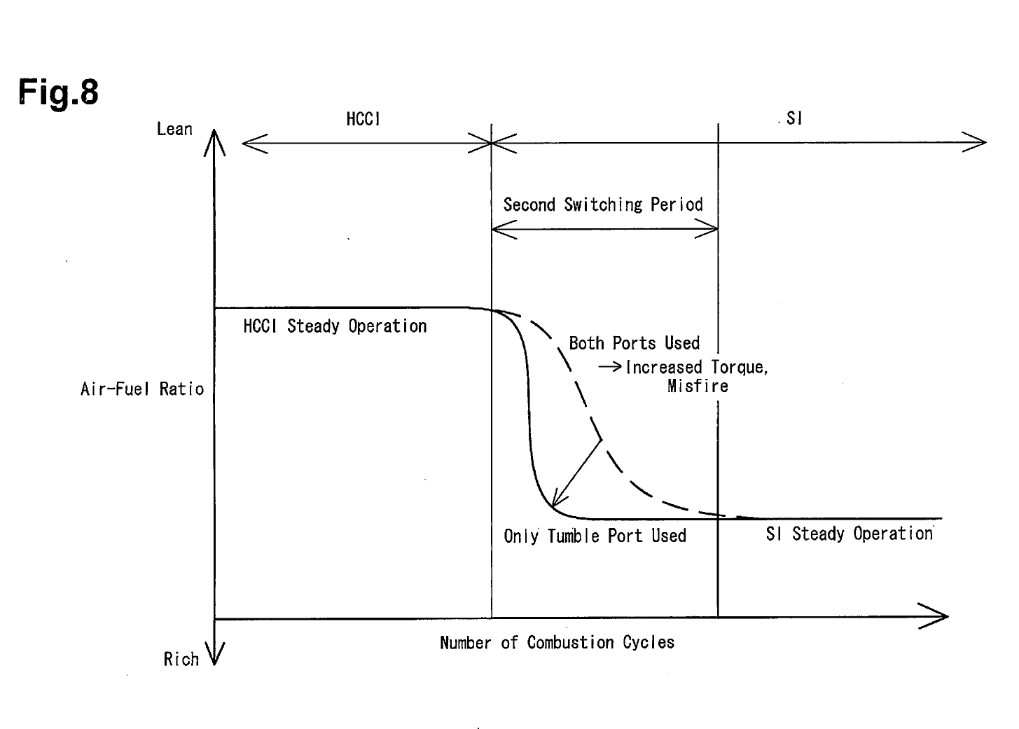

In the present embodiment, the switching period from the HCCI combustion to the SI combustion is referred to as the second switching period (see FIGS. 7 and 8). In the second switching period, the ECU 90 controls the intake port opening/closing valve 12 in such a manner as to supply the intake air from the tumble port 11p to the combustion chamber 3 (see FIGS. 3 and 5). In the second switching period, the interior of the combustion chamber 3 is prevented from being excessively cooled through introduction of the fresh air if at least the tumble port 11p is used, compared to a case in which only the swirl port 10p is used.

Further, in the second switching period, the ECU 90 controls the intake port opening/closing valve 12 in such a manner that the intake air amount falls below the value before the second switching period. Specifically, the intake port opening/closing valve 12 is operated in such a manner that the number of the intake ports maintained open in the second switching period (the tumble port 11p solely, or one intake port) becomes less than the number of the intake ports maintained open before the second switching period (the swirl port 10p and the tumble port 11p, or the two intake ports). This decreases the intake air amount in the second switching period.

Also, in the second switching period, the ECU 90 controls the throttle 13 in such a manner that the intake air amount falls below the value before the second switching period.

In the present embodiment, the ECU 90 operates in the above-described manner in the second switching period. However, if three or more intake ports are provided, the ECU 90 may operate in a manner different from the above-described manner. For example, if each of the cylinders has two swirl ports and one tumble port, all of the three ports may be used before the second switching period and only the tumble port or the tumble port and one of the swirl ports (a total of two ports) may be used in the second switching period. In other words, the ECU 90 may operate in any other suitable manner as long as three intake ports are used in the steady operation of the HCCI combustion and one or two intake ports are used in the switching period from the HCCI combustion to the SI combustion. Further, in the second switching period, the intake port opening/closing valve 12 is operated in such a manner that the intake air is supplied from at least the tumble port.

As illustrated in FIG. 7, the temperature in the combustion chamber 3 in the steady operation of the SI combustion (the SI required temperature) is higher than the temperature in the combustion chamber 3 in the steady operation of the HCCI combustion (the HCCI required temperature). In FIG. 7, the curve of the broken line shows the temperature in the combustion chamber 3 when the intake port opening/closing valve 12 is operated to supply the intake air from the swirl port 10p in the second switching period (the state illustrated in FIG. 1 or 2). As indicated by the broken line, the temperature in the combustion chamber 3 does not quickly rise in the second switching period. This may lead to a misfire and hamper smooth switch from the HCCI combustion mode to the SI combustion mode. To solve this problem, the HCCI engine 1 of the present embodiment operates the intake port opening/closing valve 12 to supply the intake air only through the tumble port 11p in the second switching period (see FIGS. 3 and 5). The curve of the solid line in FIG. 7 shows the temperature of the combustion chamber 3 in this case. Since cooling of the interior of the combustion chamber 3 is ineffective compared to the case in which the swirl port 10p is used, the temperature in the combustion chamber 3 rapidly increases to the SI required temperature. This suppresses the misfire and allows smooth switching from the HCCI combustion mode to the SI combustion mode.

Further, with reference to FIG. 8, the air-fuel ratio in the combustion chamber 3 in the steady operation of the SI combustion is lower than the air-fuel ratio in the combustion chamber 3 in the steady operation of the HCCI combustion. In FIG. 8, the curve of the broken line shows the air-fuel ratio in the combustion chamber 3 in the second switching period when the intake air is supplied from the swirl port 10p and the tumble port 11p to the combustion chamber 3 (the state illustrated in FIG. 1) and the intake air amount is changed solely through control of the throttle 13. As indicated by the broken line, the air-fuel ratio does not drop quickly in the second switching period. Such retarded drop of the air-fuel ratio is attributed to delayed operation of the throttle 13 and may lead to increased torque and/or a misfire caused by lean air-fuel mixture. To solve this problem, in the second switching period, the throttle 13 of the HCCI engine 1 of the present embodiment is controlled in such a manner that the intake air amount falls below the value in the steady operation of the HCCI combustion. Also, the intake port opening/closing valve 12 is controlled to supply the intake air exclusively through the tumble port 11p (see FIGS. 3 and 5). Thus, a decreased number of intake ports are used in the second switching period compared to the number of the intake ports (the swirl port 10p and the tumble port 11p) that are used before the second switching period. This compensates for the retardation of the operation of the throttle 13. As a result, the amount of the intake air supplied to the combustion chamber 3 quickly decreases and the air-fuel ratio in the third combustion chamber 3 rapidly drops to the air-fuel ratio in the steady operation of the SI combustion, as indicated by the solid line curve in FIG. 7. This suppresses increase of torque and misfire in the second switching period.

Further, in the second switching period, the ECU 90 controls the intake port opening/closing valve 12 and the throttle 13 in such a manner as to maintain the state of a reduced opening degree of the swirl port 10p and the decreased opening size of the throttle 13 until the intake air amount reaches the amount corresponding to the steady operation of the SI combustion. In other words, the intake port opening/closing valve 12 and the throttle 13 are operated to maintain the swirl port 10p in the state of reduced opening degree and the throttle opening size at the lowered level continuously until switching of the combustion mode is completed. As a result, the HCCI combustion mode is reliably and smoothly switched to the SI combustion mode.

The present embodiment has the following advantages.

In the present embodiment, only a swirl flow generated by cold fresh air occurs in the first switching period and cooling (heat exchange) of the interior of the combustion chamber 3 is thus efficiently brought about. This prevents premature ignition and knocking and smoothly switches the SI combustion mode to the HCCI combustion mode. In contrast, the tumble port 11p is reliably used in the second switching period. This prevents the interior of the combustion chamber 3 from being excessively cooled (combustion is maintained without becoming slow), compared to the period in which solely the swirl port 10p is used. The HCCI combustion mode is thus smoothly switched to the SI combustion mode. That is, the HCCI engine 1 of the present embodiment suppresses premature ignition and knocking in the first switching period and misfire in the second switching period, despite of its simple configuration.

In the first switching period, the ECU 90 operates the intake port opening/closing valve 12 in such a manner that the tumble port 11p is held in the closed state until the temperature in the combustion chamber 3 reaches the temperature corresponding to the steady operation of the HCCI combustion. In other words, in the first switching period, the intake port opening/closing valve 12 is controlled in such a manner that the closed state of the tumble port 11p is maintained until switching of the combustion mode is completed. Thus, the SI combustion mode is reliably and smoothly switched to the HCCI combustion mode.

The HCCI engine 1 has the throttle 13, which adjusts the amount of the intake air drawn to the combustion chamber 3. The ECU 90 controls the throttle 13 in such a manner that the intake air amount in the second switching period falls below the value before the second switching period. Through adjustment of the throttle 13, the amount of the intake air sent to the combustion chamber 3 is decreased in the second switching period.

In the second switching period, the ECU 90 controls the intake port opening/closing valve 12 and the throttle 13 until the intake air amount becomes the amount corresponding to the steady operation of the SI combustion. In other words, in the second switching period, the intake port opening/closing valve 12 and the throttle 13 are controlled continuously until switching of the combustion mode is completed. The HCCI combustion mode is thus reliably and smoothly switched to the SI combustion mode.

The throttle 13 is employed as the intake air adjustment device. The amount of the intake air supplied to the combustion chamber 3 is thus decreased by the simple structure.

In the second switching period, the ECU 90 may control the intake port opening/closing valve 12 in such a manner that the intake air amount falls below the value before the second switching period. To ensure desirable fuel consumption and heat efficiency in the HCCI combustion, the air-fuel ratio is increased compared to the value corresponding to the SI combustion, or, in other words, the interior of the combustion chamber 3 is placed in a lean state. The air-fuel mixture in the steady operation of the HCCI combustion is leaner than the air-fuel mixture in the steady operation of the SI combustion. Thus, to switch the HCCI combustion to the SI combustion, the air-fuel ratio in the combustion chamber 3 must be decreased compared to the value in the steady operation of the HCCI combustion to the value in the steady operation of the SI combustion by, for example, reducing the intake air amount. In the present embodiment, the intake air amount is decreased to rapidly reduce the air-fuel ratio in the second switching period. The HCCI combustion mode is thus smoothly switched to the SI combustion mode.

Specifically, the ECU 90 decreases the intake air amount by controlling the intake port opening/closing valve 12 in such a manner that the number of the open intake ports in the second switching period falls below the number of the open intake ports before the second switching period. To smoothly switch between engine operating modes without using the variable compression ratio mechanism disclosed in Japanese Laid-Open Patent Publication No. 2003-193872, exclusive adjustment of the opening size of the throttle 13 may be performed, for example. However, an operation delay (response delay) of the throttle 13 makes it difficult to rapidly reduce the air-fuel ratio solely by adjusting the opening size of the throttle 13. In the present embodiment, the intake air amount is quickly reduced by decreasing the number of the intake ports used in the second switching period. Thus, through the rapid decrease of the air-fuel ratio, the HCCI combustion mode is smoothly switched to the SI combustion mode. Accordingly, by the simple configuration, premature ignition and knocking in the first switching period and increase of torque and misfire in the second switching period are suppressed.

The first port is the swirl port 10p, which is shaped in such a manner as to generate a swirl flow in the combustion chamber 3. The swirl flow is thus reliably produced.

The second port is the tumble port 11p, which supplies the intake air along the stroke direction of the piston. This reliably prevents excessive cooling of the interior of the combustion chamber 3 in the second switching period through the simple configuration.

The present invention is not restricted to the above illustrated embodiment but may be modified in various forms without departing from the scope of the claims.

The “first port” is an intake port that positively supplies an intense swirl flow to the combustion chamber 3. In the illustrated embodiments, the first port is the swirl port 10p shaped in such a manner as to generate a swirl flow. However, the first port may be an intake port that supplies intake air from an opening defined near the wall surface of the combustion chamber 3 in a direction along the wall surface of the combustion chamber 3. The “second port” is a non-dedicated swirl port that does not generate a swirl flow, or produces a low-level swirl flow but does not positively generate an intense swirl flow, or can produce a flow of intake air other than swirl flow. The “low-level swirl flow” refers to a flow of intake air containing a small amount of swirl elements. In the illustrated embodiments, the second port is the tumble port 11p. However, the second port may be a straight port that is arranged at a position at which a swirl flow is not positively generated. Even such a simple configuration suppresses excessive cooling of the interior of the combustion chamber 3 in the second switching period.

1. A homogeneous charge compression ignition engine having a combustion chamber, the engine being capable of switching combustion mode between a spark ignition combustion and a homogeneous charge compression ignition combustion, the engine comprising:
a plurality of intake ports communicating with the combustion chamber, wherein the intake ports include at least one first port that is a swirl port and at least one second port that is a non-dedicated swirl port;
an intake port opening/closing device that selectively opens and closes at least the second port; and
a control section that controls the intake port opening/closing device, wherein, in a first switching period, that is a switching period in which the spark ignition combustion is switched to the homogeneous charge compression ignition combustion, the control section is adapted to control the intake port opening/closing device to close the second port so that an intake air is supplied to the combustion chamber only through the first port, and wherein, in a second switching period, that is a switching period in which the homogeneous charge compression ignition combustion is switched to the spark ignition combustion, the control section is adapted to control the intake port opening/closing device to open the second port so that the intake air is supplied through at least the second port.

2. The engine according to claim 1, wherein, in the first switching period, the control section controls the intake port opening/closing device in such a manner that the second port is maintained in a closed state until the temperature in the combustion chamber reaches a temperature corresponding to steady operation of the homogeneous charge compression ignition combustion.

3. The engine according to claim 1, wherein, in the second switching period, the control section controls the intake port opening/closing device in such a manner that the second port is maintained in an open state until the amount of the intake air becomes an amount corresponding to steady operation of the spark ignition combustion.

4. The engine according to claim 1, further comprising an intake air amount adjustment device that adjusts the amount of the intake air drawn to the combustion chamber, wherein, in the second switching period, the control section controls the intake air amount adjustment device in such a manner that the intake air amount falls below the intake air amount at the time before the second switching period.

5. The engine according to claim 4, wherein, in the second switching period, the control section controls the intake air amount adjustment device in such a manner that the intake air amount is maintained at a decreased level until the intake air amount becomes an amount corresponding to the steady operation of the spark ignition combustion.

6. The engine according to claim 4, wherein the intake air amount adjustment device is a throttle.

7. The engine according to claim 1, wherein, in the second switching period, the control section controls the intake port opening/closing device in such a manner that the intake air amount falls below the intake air amount before the second switching period.

8. The engine according to claim 7, wherein, in the second switching period, the control section controls the intake port opening/closing device in such a manner that the number of the intake ports that are open falls below the number of the intake ports that have been open before the second switching period, whereby decreasing the intake air amount.

9. The engine according to claim 1, wherein the first port is a swirl port shaped in such a manner as to generate a swirl flow in the combustion chamber.

10. The engine according to claim 1, wherein the second port generates a flow of the intake air along a stroke direction of a piston or a swirl flow less intense than the swirl flow generated by the first port.

11. The engine according to claim 1, wherein the second port is a tumble port that supplies the intake air to the combustion chamber along the stroke direction of the piston.
